(19) United States
(12) Patent Application Publication
(10) Pub. No.: US 2015/0030908 A1
(43) Pub. Date: Jan. 29, 2015

(54) POWER BATTERY PACK AND POWER BATTERY SYSTEM

(71) Applicants: Shenzhen BYD Auto R&D Company Limited, Shenzhen, Guangdong (CN); BYD Company Limited, Shenzhen, Guangdong (CN)

(72) Inventors: Yun Wang, Shenzhen (CN); Guoyong Che, Shenzhen (CN); Xuebin Zhan, Shenzhen (CN)

(21) Appl. No.: 14/376,493

(22) PCT Filed: Jan. 23, 2013
(86) PCT No.: PCT/CN2013/070900

§ 371 Date: Aug. 4, 2014

(30) Foreign Application Priority Data
Feb. 8, 2012 (CN) 201220039768.6

(51) Int. Cl. H01M 2/20; H01M 2/10; H01M 10/42

(52) U.S. Cl. CPC H01M 2/206; H01M 10/4207; H01M 2/1077; H01M 2220/20
USPC 429/158; 429/156

(57) ABSTRACT

A power battery pack and a power battery system are provided. The power battery pack comprises: a plurality of single batteries, each single battery comprising a plurality of battery units, in which an n^{th} battery unit in the plurality of battery units in each single battery is connected with an n^{th} battery unit in the plurality of battery units in an adjacent single battery in series to form an n^{th} loop, where n≧1.

### CROSS-REFERENCE TO RELATED APPLICATION

The present application claims priority to and benefits of Chinese Patent Application No. 201220039768.6 filed with the State Intellectual Property Office of P. R. China on Feb. 8, 2012, the entire contents of which are hereby incorporated by reference.

### FIELD

The present disclosure relates to a battery field, and more particularly to a power battery pack and a power battery system.

### BACKGROUND

With a continuous consumption of fuels and an increasingly serious environmental pollution, a power battery as a new energy has attracted much attention. At present, the power battery is primarily used in a new energy electric vehicle.

In order to make a distance of the electric vehicle travel longer, a capacity of the power battery needs to be increased. As a result, the number of battery cores in the power battery increases. A plurality of battery cores in the power battery are laminated or wound generally. As the capacity of the power battery increases, how to make a full use of the power battery to ensure a normal running of the electric vehicle has become a problem to be solved. At present, one electric vehicle is equipped with dozens of even hundreds of power batteries. In order to ensure an output voltage of these power batteries, the power batteries are connected in series by hardwires. Although this connection mode can provide a high output voltage, another serious problem lies in that if one of these series connected power batteries is short circuited or open circuited, it will cause an entire in-vehicle power battery circuit to work abnormally, thus causing the electric vehicle unable to run.

### SUMMARY

In order to solve at least one of the above problems, the present disclosure provides a power battery pack to solve the problem that a failure of one of series connected power batteries causes an entire in-vehicle power battery circuit to work abnormally.

According to one aspect of the present disclosure, a power battery pack is provided. The power battery pack comprises: a plurality of single batteries, each single battery comprising a plurality of battery units, wherein an nth battery unit in the plurality of battery units in each single battery is connected with an nth battery unit in the plurality of battery units in an adjacent single battery in series to form an nth loop, where n≧1.

In one embodiment, each battery unit comprises 1 to 10 battery cores and each battery core has a positive electrode tap and a negative electrode tap; positive electrode taps of the battery cores in each battery unit are connected together and led out from the single battery to form a positive electrode of each battery unit; and negative electrode taps of the battery cores in each battery unit are connected together and led out from the single battery to form a negative electrode of each battery unit.

In one embodiment, a number of the plurality of battery units ranges from 2 to 10.

In one embodiment, a number of the plurality of battery units is 2.

In one embodiment, the number of the plurality of single batteries ranges from 2 to 2000.

In one embodiment, the number of the plurality of single batteries ranges from 50 to 200.

In one embodiment, the number of the plurality of single batteries is 100.

According to another aspect of the present disclosure, a power battery system is provided. The power battery system comprises: a test switch assembly, comprising a plurality of test switches connected in parallel; and the power battery pack according to any one of claims 1-7, wherein an nth test switch is connected in series with the nth loop of the power battery pack, where n≧1.

In one embodiment, the test switch assembly further comprises a plurality of relay switches, a plurality of state collectors, a plurality of state collectors and an information processing center, and an nth relay switch is connected in series with the nth loop, one end of the nth state collector is connected with the nth loop, and the other end of the nth state collector is connected with the information processing center, where n≧1.

With the power battery pack according to embodiments of the present disclosure, by disposing the plurality of battery units in each single battery, and then connecting corresponding battery units in two adjacent single batteries in series, a plurality of single loops are formed in the battery pack. The single loops are connected in parallel to form an output loop for working normally under a normal condition. However, when a short circuit or open circuit occurring in some battery unit, a corresponding loop of a faulty battery unit will break down, but the other loops can still work normally. In this case, the power battery pack can also be used normally and the electric vehicle with the power battery pack can run normally. Accordingly, an efficiency of the power battery may be improved. In addition, with the power battery system according to embodiments of the present disclosure, by disposing the test switch assembly which comprises the plurality of test switches, each connected with one loop in the power battery pack in series respectively and then connected in parallel, it can be detected that whether respective loop in the power battery pack works normally, and a faulty loop can be disconnected in time to reduce a security risk.

### BRIEF DESCRIPTION OF THE DRAWINGS

These and other aspects and advantages of the invention will become apparent and more readily appreciated from the following descriptions taken in conjunction with the drawings in which:

FIG. 1 is a schematic diagram illustrating a power battery pack according to an embodiment of the present disclosure;

FIG. 2 is a schematic diagram illustrating a first single battery in the power battery pack in FIG. 1; and

FIG. 3 is a schematic diagram illustrating a power battery system and an electric vehicle system using the power battery system according to an embodiment of the present disclosure.

### DETAILED DESCRIPTION

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

It should be noted that, terms such as “the first”, “the second” are only used to describe and should not be understood as the quality of the relatively important or implicitly indicated technology features. Thus, the features marked “the first”, “the second” may explicitly or implicitly indicate one or more features included. In the description of the present disclosure, “multiple” means two or two more except for another illustration.

In the description of the present disclosure, it needs to understand, terms such as “fixed”, “attached”, “connected” should be understood generally, such as, the fixed connection, permanent connection or the connection in one body; also, the mechanism connection or the electric connection; the direct connection, indirect connection via a medium or the inner connection between two components. To any person skilled in the art, the specific meaning of the aforementioned words in the present disclosure may be understood according to the specific situation.

A power battery pack is provided according to an embodiment of the present disclosure. The power battery pack comprises: a plurality of single batteries, each single battery comprising a plurality of battery units, wherein an n^{th} battery unit in the plurality of battery units in each single battery is connected with an n^{th} battery unit in the plurality of battery units in an adjacent single battery in series to form an n^{th} loop, where n≧1.

It should be noted that, in following embodiments, the power battery pack comprising four single batteries, each single battery comprising two battery units, and each battery unit comprising two battery cores are taken as an example discussed in combination with drawings. However, the specific number should not be understood as limiting the present disclosure.

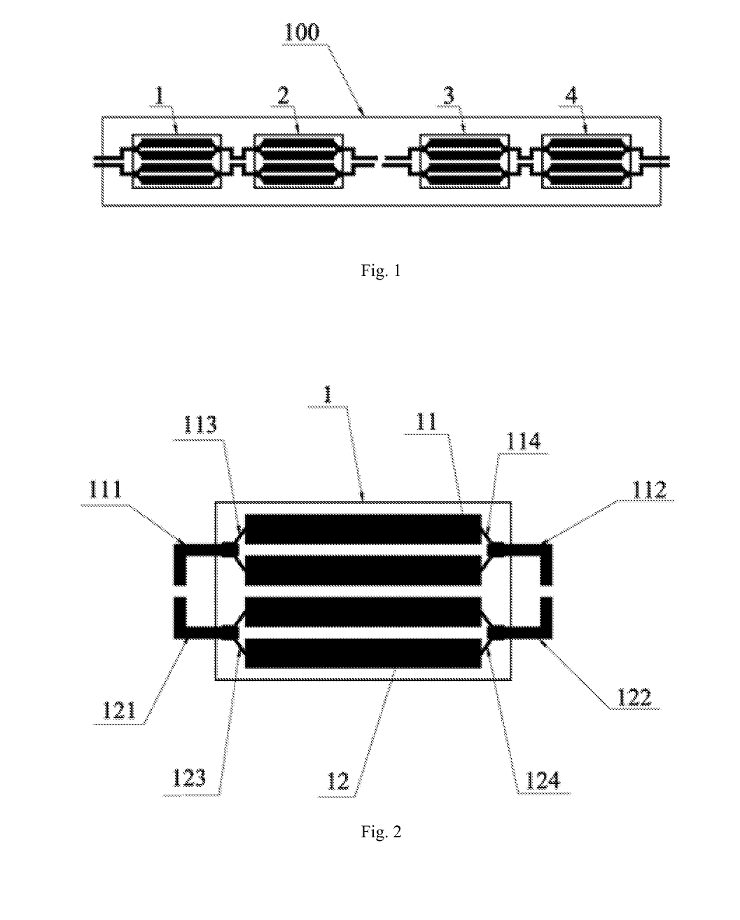

FIG. 1 is a schematic diagram of the power battery pack according to an embodiment of the present disclosure. As shown in FIG. 1, the power battery pack 100 comprises a first single battery 1, a second single battery 2, a third single battery 3 and a fourth single battery 4.

FIG. 2 is a schematic diagram of a first single battery in the power battery pack 100 in FIG. 1. As shown in FIG. 2, each single battery has an identical structure. Taking the first single battery 1 as an example, the first single battery 1 comprises two battery units: a first battery unit 11 and a second battery unit 12.

The first battery unit 11 in the first single battery 1 and the first battery unit in the second single battery 2 are connected in series, the first battery unit in the second single battery 21 and the first battery unit in the third single battery 3 are connected in series, and the first battery unit in the third single battery 3 and the first battery unit in the fourth single battery 4 are connected in series, that is, the first battery units in all the single batteries are connected in series to form a first loop.

The second battery unit 12 in the first single battery 1 and the second battery unit in the second single battery 2 are connected in series, the second battery unit in the second single battery 2 and the second battery unit in the third single battery 3 are connected in series, and the second battery unit in the third single battery 3 and the second battery unit in the fourth single battery 4 are connected in series, that is, the second battery units in all the single batteries are connected in series to form a second loop. In this embodiment, two single loops are formed in the power battery pack.

As shown in FIG. 2, the first battery unit 11 in the first single battery 1 has a positive electrode 111 and a negative electrode 112, and the second battery unit 12 in the first single battery 1 has a positive electrode 121 and a negative electrode 122.

A structure of the first loop is that: the positive electrode 111 of the first battery unit 11 in the first single battery 1 is connected to the negative electrode of the first battery unit in the second single battery 2, the positive electrode of the first battery unit in the second single battery 2 is connected to the negative electrode of the first battery unit in the third single battery 3, the positive electrode of the first battery unit in the third single battery 3 is connected to the negative electrode of the first battery unit in the fourth single battery 4, and then a current is led in from the positive electrode of the first battery unit in the fourth single battery 4 and led out from the negative electrode 112 of the first battery unit 11 in the first single battery 1 to form the first loop.

Or, the negative electrode 112 of the first battery unit 11 in the first single battery 1 is connected to the positive electrode of the first battery unit in the second single battery 2, the negative electrode of the first battery unit in the second single battery 2 is connected to the positive electrode of the first battery unit in the third single battery 3, the negative electrode of the first battery unit in the third single battery 3 is connected to the positive electrode of the first battery unit in fourth single battery 4, and then a current is led in from the positive electrode 111 of the first battery unit 11 in the first single battery 1 and led out from the negative electrode of the first battery unit in the fourth single battery 4 to form the first loop.

Similarly, a structure of the second loop is that: the positive electrode 121 of the second battery unit 12 in the first single battery 1 is connected to the negative electrode of the second battery unit in the second single battery 2, the positive electrode of the second battery unit in the second single battery 2 is connected to the negative electrode of the second battery unit in the third single battery 3, the positive electrode of the second battery unit in the third single battery 3 is connected to the negative electrode of the second battery unit in the fourth single battery 4, and then a current is led in from the positive electrode of the second battery unit in the fourth single battery 4 and led out from the negative electrode of the second battery unit 2 in the first single battery 1 to form the second loop.

Or, the negative electrode 112 of the second battery unit 12 in the first single battery 1 is connected to the positive electrode of the second battery unit in the second single battery 2, the negative electrode of the second battery unit in the second single battery 2 is connected to the positive electrode of the second battery unit in the third single battery 3, the negative electrode of the second battery unit in the third single battery 3 is connected to the positive electrode of the second battery unit in the fourth single battery 4, and then a current is led in from the positive electrode 121 of the second battery unit 12 in the first single battery 1 and led out from the negative electrode of the second battery unit in the fourth single battery 4 to form the second loop.

A battery unit comprises 1 to 10 battery cores, each battery core has an anode tap and a negative electrode tap; all the anode taps of the battery cores are connected together to form a anode of the battery unit; and all the negative electrode taps of the battery cores are connected together to form a negative electrode of the battery unit.

As shown in FIG. 2, in the first single battery 1, both the first battery unit 11 and the second battery unit 12 comprise two battery cores, and each battery core comprises a positive tap and a negative electrode tap.

Positive electrode taps of the battery cores in each battery unit are connected together and led out from the single battery to form a positive electrode of each battery unit; and negative electrode taps of the battery cores in each battery unit are connected together and led out from the single battery to form a negative electrode of each battery unit.

Specifically, the positive electrode taps of the two battery cores of the first battery unit 11 in the first single battery 1 are connected together by a welding transition piece 113 and then led out from the first single battery 1 to form the positive electrode of the first battery unit 11. Similarly, the negative electrode taps of the two battery cores of the first battery unit 11 in the first single battery 1 are connected together by a welding transition piece 114 and then led out from the first single battery 1 to form the negative electrode of the first battery unit 11.

Similarly, the positive electrode taps of the two battery cores of the second battery unit 12 in the first single battery 1 are connected together by a welding transition piece 123 and then led out from the first single battery 1 to form the positive electrode of the second battery unit 12. Similarly, the negative electrode taps of the two battery cores of the second battery unit 12 in the first single battery 1 are connected together by a welding transition piece 124 and then led out from the first single battery 1 to forma negative electrode of the second battery unit 12.

It should be noted that, the battery core, the welding transition piece and battery tap mentioned in the present disclosure are known to those skilled in this field.

With the power battery pack according to embodiments of the present disclosure, by disposing the plurality of battery units in each single battery, and then connecting corresponding battery units in two adjacent single batteries in series, a plurality of single loops are formed in the battery pack. The single loops are connected in parallel to form an output loop for working normally under a normal condition. However, when a short circuit or open circuit fault occurring in some battery unit, a corresponding loop of a faulty battery unit will break down, but the other loops can still work normally. In this case, the power battery pack can also be used normally and the electric vehicle with the power battery pack still can run normally. Therefore, an efficiency of the power battery may be improved.

Compared with a power battery in the prior art, the power battery pack according to the present disclosure is safer and more reliable with higher efficiency. When a failure occurs to the power battery pack, it can reduce a risk of a break down of the electric vehicle.

A power battery system is provided according to another aspect of the present disclosure. The power battery system comprises: a test switch assembly, comprising a plurality of test switches connected in parallel; and the power battery pack provided by the first aspect of the present disclosure, in which an n^{th} test switch is connected in series with the n^{th} loop of the power battery pack, where n≧1. The test switch assembly further comprises a plurality of relay switches, a plurality of state collectors, a plurality of state collectors and an information processing center, and an n^{th} relay switch is connected in series with the n^{th} loop, one end of the n^{th} state collector is connected with the n^{th} loop, and the other end of the n^{th} state collector is connected with the information processing center, where n≧1.

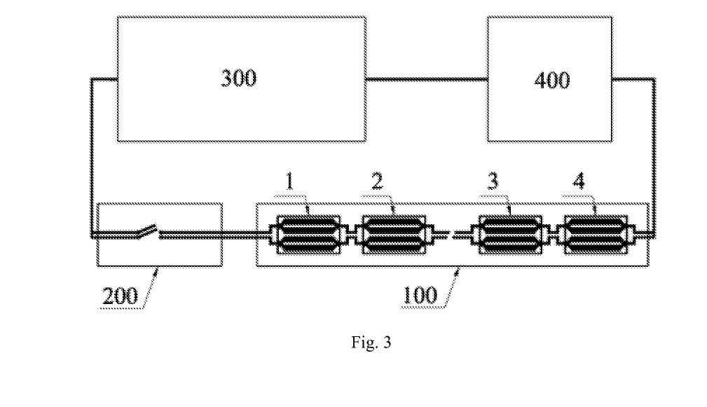

FIG. 3 is a schematic diagram of the power battery system according to an embodiment of the present disclosure. As shown in FIG. 3, the power battery system comprises a test switch assembly 200 and the power battery pack 100.

In this embodiment, the test switch assembly 200 comprises two test switches (i.e., a first test switch and a second test switch) connected in parallel. The first test switch is connected with the first loop in the power battery pack 100 in series, and the second test switch is connected with the second loop in the power battery pack 100 in series. In this embodiment, the first test switch and the second test switch are identical.

In this embodiment, the test switch assembly further comprises two relay switches (i.e., a first relay switch and a second switch), two state collectors (i.e., a first state collector and a second state collector) and one processing center (all these components are not shown in FIG. 3). The first relay switch is connected with the first loop in series, one end of the first state collector is connected with the first loop, and the other end of the first collector is connected with the processing center. The second relay switch is connected with the second loop, one end of the second state collector is connected with the second loop, and the other end of the state collector is connected with the processing center.

In embodiments of the present disclosure, the relay switch, the state collector and the processing center are known to those skilled in this field. It should be noted that each state collector and the corresponding loop can be connected in series or in parallel, which is not specifically restricted by the present disclosure. Specifically, each state collector detects over voltage, an under voltage, an over current, a short circuit, a temperature or other fault, and then feeds back detected singles to the processing center. The processing center processes the detected singles from the state collector, and then sends a switch-off instruction to the corresponding relay switch to break the corresponding loop, while the other loops still work normally to ensure a normal usage of the power battery pack.

The power battery system may be further applied to an electric vehicle. FIG. 3 further shows an electric vehicle system using the power battery system. As shown in FIG. 3, the electric vehicle comprises an electric vehicle control system 300 and a drive motor 400. The power battery system and the drive motor 400 are connected in series by hard wires, and the power battery system and the vehicle control system 300 are connected in series by hard wires. Each loop in the power battery pack 100 can be detected in time by a security self-check function of the test switch assembly 200. For example, when a fault occurs to one first battery unit of some single battery, the first test switch detects the fault in time and breaks the first loop automatically, while the second loop keeps working with a half capacity of the power battery pack to ensure the normal running of the vehicle.

The power battery pack according to embodiments of the present disclosure can be applied to electric vehicles, energy storage power stations, mobile storage terminals, etc.

Although explanatory embodiments have been shown and described, it would be appreciated by those skilled in the art that changes, alternatives, and modifications can be made in the embodiments without departing from spirit and principles of the disclosure. Such changes, alternatives, and modifications all fall into the scope of the claims and their equivalents.

1. A power battery pack, comprising:
a plurality of single batteries, each single battery comprising a plurality of battery units,
wherein an n^{th} battery unit in the plurality of battery units in each single battery is connected with an n^{th} battery unit in the plurality of battery units in an adjacent single battery in series to form an n^{th} loop, where n≧1.

2. The power battery pack of claim 1, wherein
each battery unit comprises 1 to 10 battery cores and each battery core has a positive electrode tap and a negative electrode tap;
positive electrode taps of the battery cores in each battery unit are connected together and led out from the single battery to form a positive electrode of each battery unit; and
negative electrode taps of the battery cores in each battery unit are connected together and led out from the single battery to form a negative electrode of each battery unit.

3. The power battery pack of claim 1, wherein a number of the plurality of battery units ranges from 2 to 10.

4. The power battery pack of claim 3, wherein a number of the plurality of battery units is 2.

5. The power battery pack of claim 1, wherein a number of the plurality of single batteries ranges from 2 to 2000.

6. The power battery pack of claim 5, wherein the number of the plurality of single batteries ranges from 50 to 200.

7. The power battery pack of claim 6, wherein, the number of the plurality of single batteries is 100.

8. A power battery system, comprising:
a test switch assembly, comprising a plurality of test switches connected in parallel; and
the power battery pack, comprising: a plurality of single batteries, each single battery comprising a plurality of battery units,
wherein an n^{th} battery unit in the plurality of battery units in each single battery is connected with an n^{th} battery unit in the plurality of battery units in an adjacent single battery in series to form an n^{th} loop, an n^{th} test switch is connected in series with the n^{th} loop of the power battery pack, where n≧1.

9. The power battery system of claim 8, wherein
the test switch assembly further comprises a plurality of relay switches, a plurality of state collectors, a plurality of state collectors and an information processing center, and
an n^{th} relay switch is connected in series with the n^{th} loop, one end of the n^{th} state collector is connected with the n^{th} loop, and the other end of the n^{th} state collector is connected with the information processing center, where n≧1.

10. The power battery pack of claim 8, wherein
each battery unit comprises 1 to 10 battery cores and each battery core has a positive electrode tap and a negative electrode tap;
positive electrode taps of the battery cores in each battery unit are connected together and led out from the single battery to form a positive electrode of each battery unit; and
negative electrode taps of the battery cores in each battery unit are connected together and led out from the single battery to form a negative electrode of each battery unit.

11. The power battery pack of claim 8, wherein a number of the plurality of battery units ranges from 2 to 10.

12. The power battery pack of claim 11, wherein a number of the plurality of battery units is 2.

13. The power battery pack of claim 8, wherein a number of the plurality of single batteries ranges from 2 to 2000.

14. The power battery pack of claim 13, wherein the number of the plurality of single batteries ranges from 50 to 200.
